(19) United States
(12) Patent Application Publication
(10) Pub. No.: US 2024/0223630 A1
(43) Pub. Date: Jul. 4, 2024

(54) METHOD FOR SOCIAL GROUP DATA MANAGEMENT

(71) Applicant: Yang Lee, New Taipei City (TW)

(72) Inventor: Yang Lee, New Taipei City (TW)

(21) Appl. No.: 18/399,321

(22) Filed: Dec. 28, 2023

(30) Foreign Application Priority Data
Dec. 28, 2022 (TW) 111150492

(51) Int. Cl. H04L 65/403; H04L 51/52

(52) U.S. Cl. CPC H04L 65/403; H04L 51/52

(57) ABSTRACT

A method for social group data management is provided. The method includes a server receiving a social group setup requirement and first user information from a first user terminal, and generating a social group list in responding to the social group setup requirement, where the social group list includes the first user information; the server receiving a social group joining requirement and second user information from a second user terminal, and adding the second user information into the social group list in responding to the social group joining requirement; the server receiving a social group leaving requirement from the second user terminal, and transmitting the social group leaving requirement to the first user terminal; and the server receiving a permitting message from the first user terminal, and deleting the second user information in the social group list in responding to the permitting message.

### CROSS-REFERENCE TO RELATED APPLICATION

This non-provisional application claims priority under 35 U.S.C. § 119(a) to Patent Application No. 111150492 filed in Taiwan, R.O.C. on Dec. 28, 2022, the entire contents of which are hereby incorporated by reference.

### BACKGROUND

### Technical Field

The present disclosure relates to a method for data management, and particularly relates to a method for social group data management.

### Related Art

Traditional e-commerce transactions are performed in different business models such as source supply and vendor supply. In the source supply model, orders are uniformly received from consumers by a platform, and then goods are centrally shipped by a single vendor, such as PChome or Amazon site. In the vendor supply model, orders are uniformly received from the consumers by a platform, then the goods are shipped by individual vendors, and the platform only manages logistics status, such as Shopee or eBay site. In recent years, with the advancement of social group software platforms, a new community ordering model has gradually developed based on the vendor supply model. In the community ordering model, the social group software platform does not intervene in consumers' shopping behavior. In this model, the consumers use social group software to gather multiple consumers with the same shopping needs to make group purchases from one or more specific vendors.

Since the outbreak of Covid-19, because of the home quarantine policy or the interruption of the logistics chain in remote areas, the trend of the consumers using the social group software platforms to order in a community unit has become increasingly popular. For example, in the same community, the person in charge of group purchases sets up a chat group for multiple community members in the social group platform (such as Line or Facebook). The person in charge promotes in the chat group and gathers the community members with the similar shopping needs to place orders from specific vendors, and then the person in charge will receive the goods and distribute to the community members.

The current community ordering model lacks platform management, and its operation is based on the geographical location and trust relationship between the person in charge of the group purchases and the community members. When transaction disputes occur, the community members may seek resolution from the person in charge of the group purchases or the local community management committee. However, if the community ordering model is expanded to multiple regions, when the transaction dispute occurs, since the two parties to the transaction do not have geographical location or trust foundation and because of the anonymity of the social group software, if one party to the transaction leaves the chat group, it becomes difficult for the other party to seek a solution channel. On the other hand, the group purchases usually require a certain number of transaction members to meet vendor shipping or discount goals. If the parties to the transaction cannot be determined or there are not enough people involved, it will result in the group dissolving and the transaction failing.

### SUMMARY

In view of this, the applicant provides a method for social group data management, applying to a server; the server is suitable for being connected to a first user terminal and a second user terminal; and the method includes: the server receiving a first social group setup requirement and first user information from the first user terminal, and generating a first social group list in responding to the first social group setup requirement, where the first social group list includes the first user information; the server receiving a social group joining requirement and second user information from the second user terminal, and adding the second user information into the first social group list in responding to the social group joining requirement; the server receiving a social group leaving requirement from the second user terminal, and transmitting the social group leaving requirement to the first user terminal; and the server receiving a permitting message from the first user terminal, and deleting the second user information in the first social group list in responding to the permitting message.

### BRIEF DESCRIPTION OF THE DRAWINGS

FIG. 1 is a schematic block diagram of a system for social group data management according to one embodiment of the present disclosure.

FIG. 2 is a flowchart of a method for social group data management according to one embodiment of the present disclosure.

FIG. 3 is a flowchart of a method for social group data management according to another embodiment of the present disclosure.

### DETAILED DESCRIPTION

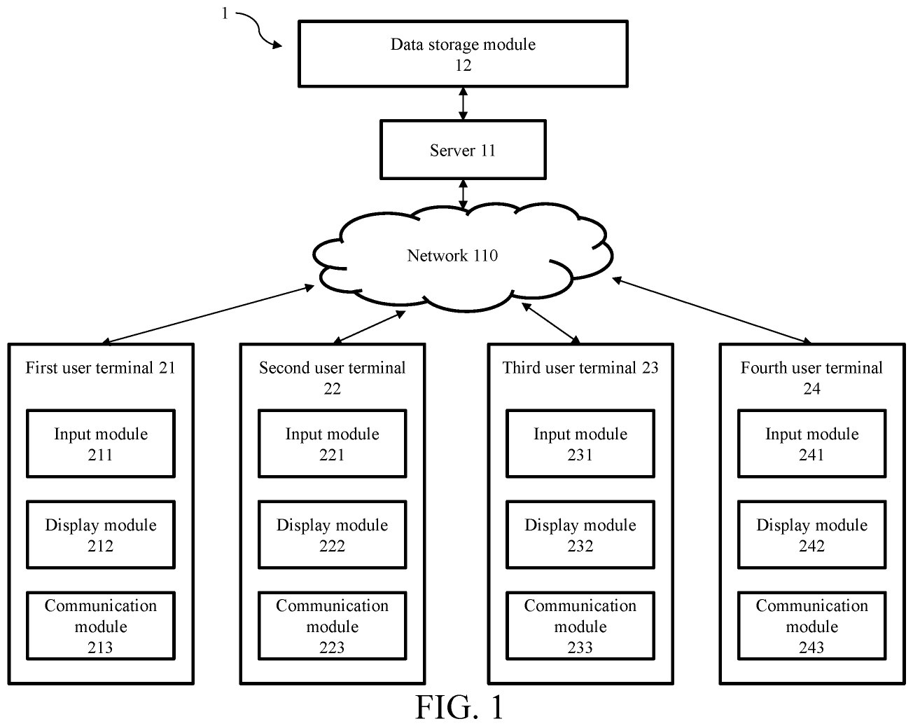

FIG. 1 is a schematic block diagram of a system for social group data management according to one embodiment of the present disclosure, please refer to FIG. 1. In this embodiment, a system 1 for social group data management includes a server 11, a data storage module 12, a first user terminal 21, a second user terminal 22, a third user terminal 23 and a fourth user terminal 24. The data storage module 12 is coupled to the server 11, and the server 11 is coupled to the first user terminal 21, the second user terminal 22, the third user terminal 23 and the fourth user terminal 24 through a network 110 (wired or wireless communication network, such as Internet, a 3G network and/or a wireless local area network (WLAN)). The first user terminal 21, the second user terminal 22, the third user terminal 23 and the fourth user terminal 24 correspondingly include input modules 211, 221, 231 and 241, display modules 212, 222, 232 and 242, and communication modules 213, 223, 233 and 243.

The server 11 includes one or more processors, and a memory coupled to the processors; and the memory includes instructions executable by the processors, and the processors can execute the instructions to run a method for social group data management according to one or more embodiments of the present disclosure. The processors may be an SoC chip, a central processing unit (CPU), a Micro-Control Unit (MCU), an Application Specific Integrated Circuit (ASIC), a Field Programmable Gate Array (FPGA) or a logic circuit. The memory may be a flash memory or a Read-Only Memory (ROM), such as but not limited to an Erasable Programmable Read-Only Memory (EPROM), a Flash Read-Only Memory (Flash ROM), an Electrically-Erasable Programmable Read-Only Memory (EEPROM) or a Field-Replaceable Unit EEPROM (FRU EEPROM).

The data storage module 12 can be an apparatus for storing information in an electric, magnetic or optical mode and the like, such as but not limited to a hard disk, a random access memory (RAM), a read-only memory (ROM), an optical disk, a floppy disk and a magnetic tape. The data storage module 12 is controlled by the server 11 to store at least one or more pieces of information, social group list or transaction information associated with a user. The user information may include one or more pieces of information such as name, account, password, image, gender, address, transaction history and transaction object of the user. The social group list may include user information of a manager, user information of social group members and social group information. The social group information may include one or more pieces of information such as social group name, belonging area (such as administrative region information, geographic positioning information and a user-defined range), transaction object category (such as audio transaction, jewelry transaction or daily supplies), number of members, number of likes, number of sharing, number of comments, comment content, number of viewing times, and number of viewing hours. The transaction information may include pictures, characters, sounds and films generated in the user interaction process, and information of transaction objects, such as but not limited to name, materials, specification, size, weight, capacity, number, color, package, volume, shipment area, delivery area, distances between the shipment area and the delivery area, shipment time, delivery time, and transaction remark. In some embodiments, the transaction is not limited to cash transaction and may also refer to purposeful communication activities such as work sharing.

The user terminal can be a portable apparatus or a handheld apparatus, such as but not limited to electronic computing apparatus like a smart phone, a tablet personal computer, a mobile phone, a notebook computer, a vehicle computer, and a personal digital assistant (PDA). The user terminal includes the communication modules 212, 223, 233 or 243 for transmitting and receiving a network data packet. The communication modules 213, 223, 233 and 243 can support one or more communication protocols, such as but not limited to communication protocols like a Global System for Mobile communication (GSM), a Personal Handy-phone System (PHS), a Code Division Multiple Access (CDMA) system, a Wideband Code Division Multiple Access (WCDMA) system, a Long Term Evolution (LTE) system, a Worldwide interoperability for Microwave Access (WiMAX) system, Wireless Fidelity (Wi-Fi), ZigBee, Bluetooth, and Radio Frequency (RF).

The user terminal receives information from the network 110 by the communication modules 213, 223, 233 or 243, and presents the information to the user by the display modules 212, 222, 232 or 242; and the input modules 211, 221, 231 or 241 receive the information from the user, and transmit the information to the server 11 through the network 110 by the communication modules 213, 223, 233 or 243. The input modules 211, 221, 231 and 241 may be at least one element selected from a touch screen, a touch pad, a mouse, a keyboard, a microphone, a camera and the like and used for receiving data or an operation instruction inputted by the user, and the input data may be characters, images or sounds.

In some embodiments, the server 11 according to the present disclosure runs the method for social group data management to set up social group platforms such as communication, video, live broadcast, chat, audio and video, trading, friend making, game and document operation systems. For the social group platforms, it is not easy to admit members (such as fans, full members or group purchase members) and they are operated by the social group managers alone for marketing and management; and moreover, it is not easy to perform interaction among the social groups, and it is difficult to directly spread information. Therefore, by joining (a sub-social group becomes a subset of a mother social group, namely the sub-social group is deleted) or merging (the sub-social group and the mother social group are integrated, namely the sub-social group and the mother social group coexist) the social groups, the social group members can achieve a specific goal together, and moreover, the social group scale can be more quickly expanded. In addition, it is allowed to merge a plurality of social groups to generate a new social group which is subjected to unified management by the platform, so that transaction disputes or social disputes happened during social group communication are avoided. The following embodiments are described by setting up a trading platform in a community ordering mode by the method for the social group data management.

The transactions in the existing community ordering model focus on browsing and communication on the transaction objects through social group platforms such as Line or Facebook; and however, when conducting transactions, there are buying and selling problems such as inconsistent prices, payment security, and untrue transaction objects. In addition, since both the seller and the buyer are individual users of the social group software, it is difficult to efficiently manage the delivery, payment, and customer service of orders, and as a result, the business scale is limited to transactions in a small area and has a limit on the number of members. Moreover, certain transactions result in higher logistics costs, for example, the shipping costs incurred by two consumers in a zone B separately ordering the same item from a vendor in a zone A are nearly twice as much as the shipping costs incurred by two consumers in the zone B ordering the same item together from the vendor in the zone A.

In some embodiments, the user can set up individual social groups (such as social group for group purchases) with the method for social group data management. Other users may join the existing social groups for transactions. In existing social group platforms, the users freely entering and exiting interaction groups may lead to unstable transactions. For example, the buyer leaves the social group after the seller ships the goods, leaving the seller unable to contact the buyer. Therefore, the platform allows a user or a social group A to join or merge into a social group B, and then the trading activities of the social group B is subjected to unified management.

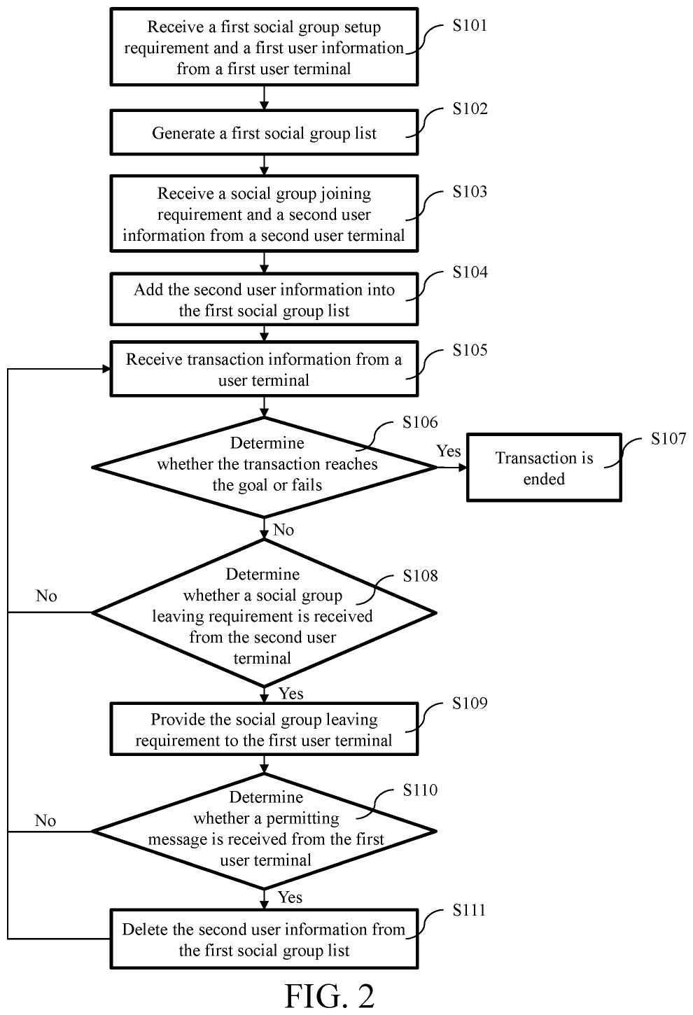

FIG. 2 is a flowchart of a method for social group data management according to one embodiment of the present disclosure, please refer to FIG. 2. In this embodiment, according to the method for social group data management, a first social group setup requirement and first user information are received from the first user terminal 21 (step S101). In the system 1 for social group data management, a first user transmits the first social group setup requirement through the first user terminal 21, and the server 11 sets up a social group (hereinafter referred to as a first social group) in responding to the first social group setup requirement. In this embodiment, the server 11 generates a first social group list according to the first user information (step S102), and the first social group list includes the first user information. In other embodiments, besides the first user information, the server 11 receives third user information (or more other user information) at the same time, and the server 11 generates a first social group list including the first user information and the third user information. In the transaction process, the server 11 receives a social group joining requirement and second user information from the second user terminal 22 (step S103). In this embodiment, the server 11 directly adds the second user information into the first social group list in responding to the social group joining requirement (step S104). In other embodiments, the server 11 provides the social group joining requirement to the first user terminal 21, and adds the second user information into the first social group list only after receiving a permitting message from the first user terminal 21 (step S104).

In this embodiment, the second user requires to join the first social group. In other embodiments, the second social group requires to be integrated with the first social group, and the second social group includes the second user. Specifically, the server 11 receives the second social group setup requirement and the second user information from the second user terminal 22, and the server 11 generates the second social group list in responding to the second social group setup requirement, and the second social group list includes the second user information. Or, besides the second user information, the server 11 receives fourth user information (or more other user information), and the server 11 generates a second social group list including the second user information and the fourth user information. When the server 11 receives the social group integration requirement from the second user terminal 22, the server 11 will add information in the second social group list into the first social group list in responding to the social group integration requirement, such as the second user information or other user information. For example, the first social group list originally includes the first user information and the third user information, the second social group list originally includes the second user information and the fourth user information, and the first social group list includes the first user information, the second user information, the third user information and the fourth user information after merging. In other embodiments, after the server 11 receives the social group integration requirement from the second user terminal 22, the server 11 generates a third social group list in responding to the social group integration requirement, and the third social group list includes the information in the first social group list and the information in the second social group list. In this case, the third social group is a new social group generated based on the first social group and the second social group.

In some embodiments, integration may refer to joining or merging; the second social group joins the first social group, thus the second social group becomes a subset of the first social group, or alternatively, the second social group merges with the first social group, thus the second social group and the first social group becomes a union. In some embodiments, after the first social group is integrated with the second social group, the server 11 will delete the second social group list of the second social group. Therefore, all members of the second social group completely join the first social group, and the original second social group does not exist anymore. In other embodiments, after the first social group is integrated with the second social group, the server 11 still maintains the first social group list of the first social group and the second social group list of the second social group. Therefore, all members of the first social group and the second social group still exist in original social groups. In this case, the first social group and the second social group still exist independently, and still can admit members individually.

As shown in FIG. 2 again, when a social group is set up, the server 11 will receive transaction information from the user terminal (step S105), and the user interacts with a platform of the server 11 through the user terminal, so as to achieve a transaction activity. In the transaction process, in some embodiments, after the second social group joins the first social group, and if the platform user retrieves the second social group on a platform interface, the platform will return the information of the first social group in responding to a retrieval requirement. In some embodiments, the returned information includes related information that the second social group becomes an affiliated social group of the first social group, for example, the second social group has become the affiliated social group of the first social group on 2023/1/1. In other embodiments, after the second social group is merged with the first social group, and if the platform user retrieves the first social group or the second social group on the platform interface, the platform will return the information of a united social group of the first social group and the second social group in responding to the retrieval requirement. In some embodiments, the returned information includes related information that the first social group and the second social group are united social groups, for example, the first social group and the second social group have become the united social groups on 2023/1/1. In the transaction activity, after the second social group joins the first social group, text data uploaded to the server 11 by the members of the original second social group will be displayed on the interface of the first social group; and after the second social group is merged with the first social group, the text data uploaded to the server 11 by the members of the original first social group or the second social group will be displayed on the united interface of the first social group and the second social group. In some embodiments, in step S105, the server 11 receives the transaction information from a fifth user terminal (not shown in the figure) not joining the first social group or the second social group, and puts the transaction information into the first social group or the united social group of the first social group and the second social group. For example, the fifth user terminal is a marketing company, vendors, or members of the platform, and it has the capability to place advertisements or obtain information about buying or selling offers from a social group, even though it is not a member, through the platform.

In the transaction activity, the server 11 will determine whether the transaction reaches the goal or fails (step S106), for example, the set number of people for group purchase is reached, or the group purchase time is up and the number of people is still not reached. In this embodiment, when the server 11 determines that the transaction reaches the goal or fails (step S106, the determination result is “Yes”), the transaction activity will be ended (step S107). In some embodiments, the newly generated social group is a social group with a purpose (for example, group purchase of vegetables), and the social group will be disassociated after the transaction activity is ended (the transaction purpose is reached or failed). In other embodiments, after the transaction activity is ended, the newly generated social group still exists for next transaction.

When the server 11 determines that the transaction does not reach the goal and does not fail (step S106, the judgment result is “No”), the transaction activity will be continued. In the transaction activity, the server 11 will determine whether a social group leaving requirement is received from the second user terminal 22 (step S108). If the server 11 determines that the social group leaving requirement is not received from the second user terminal 22 (step S108, the judgment result is “No”), the transaction information will be continuously received from the user terminal (step S105) for the transaction activity; and if the server 11 determines that the social group leaving requirement is received from the second user terminal 22 (step S108, the judgment result is “Yes”), the social group leaving requirement will be provided to the first user terminal 21 (step S109). Then, the server 11 will determine whether a permitting message is received from the first user terminal 21 (step S110). If the server 11 determines that the permitting message is not received from the first user terminal 21 (step S110, the judgment result is “No”), for example, the first user does not reply or not permit, the server 11 does not respond to the social group leaving requirement of the second user terminal 22, and the transaction information will be continuously received from the user terminal (step S105) for the transaction activity; and if the server 11 determines that the permitting message is received from the first user terminal 21 (step S110, the judgment result is “Yes”), the second user information will be deleted from the first social group list (step S111). In this embodiment, the server 11 platform intervenes in the transaction activity between the first social group and the second user, and thus the second user cannot leave the group purchase social group by himself to avoid the transaction failure. It is to be noted that the steps in the flowchart according to the embodiment do not necessarily need to be carried out according to the numerical sequence, for example, step S106 and step S107 can be performed after step S111 or before step S105.

In this embodiment, when the first user permits the leaving of the second user, the server 11 will delete the second user information from the first social group list. In other embodiments, under a condition that the second user integrates the second social group into the first social group, when the first user permits the leaving of the second social group (including the second user), the server 11 will delete the information in the second social group list from the first social group list. In other embodiments, under a condition that the second user integrates the second social group into the first social group to generate a third social group, when the first user permits the leaving of the second social group (including the second user), the server 11 will delete the information in the second social group list from the third social group list.

In some embodiments, the server 11 receives the first social group setup requirement and the first user information from the first user terminal 21 (step S101), and further receives a quantity goal and a first sequence condition goal set by the first user at the same time. For example, when the first user sets up a first social group for group purchase of vegetables, the group purchase quantity and the estimated area range for gathering for group purchase are set at the same time. In this embodiment, the quantity goal refers to the number of people for group purchase. In other embodiments, the quantity goal can be the number of people, the number of transactions, the number of transaction objects, the number of fans, the number of viewing times, the number of likes, the number of sharing or the number of comments. The condition goal may refer to the administrative region range, the geographic region range, and the transportation range corresponding to the equal logistics prices. The condition goal may have sequence, for example, a seller in Taipei City sets Taipei City and New Taipei City as the first sequence condition goals and sets Taoyuan City and Yilan City as the second sequence condition goals. In this embodiment, the first user sets the first social group and sets the first sequence condition goal at the same time, and the second sequence condition goal may be set when or after the first social group is set.

In some embodiments, the second user sets up the second social group. The server 11 can receive condition information from the second user terminal 22 and then sets up the second social group. The condition information corresponds to the condition goal. For example, the second user sets up the second social group and records (the user actively sets or the user terminal automatically generates) a region to which the social group belongs at the same time, such as a regional group purchase community in Da'an District of Taipei city. The condition information may refer to the administrative region range, the geographic region range and the target logistics price. Therefore, the condition information set by the second social group can be compared with the condition goal of the first social group.

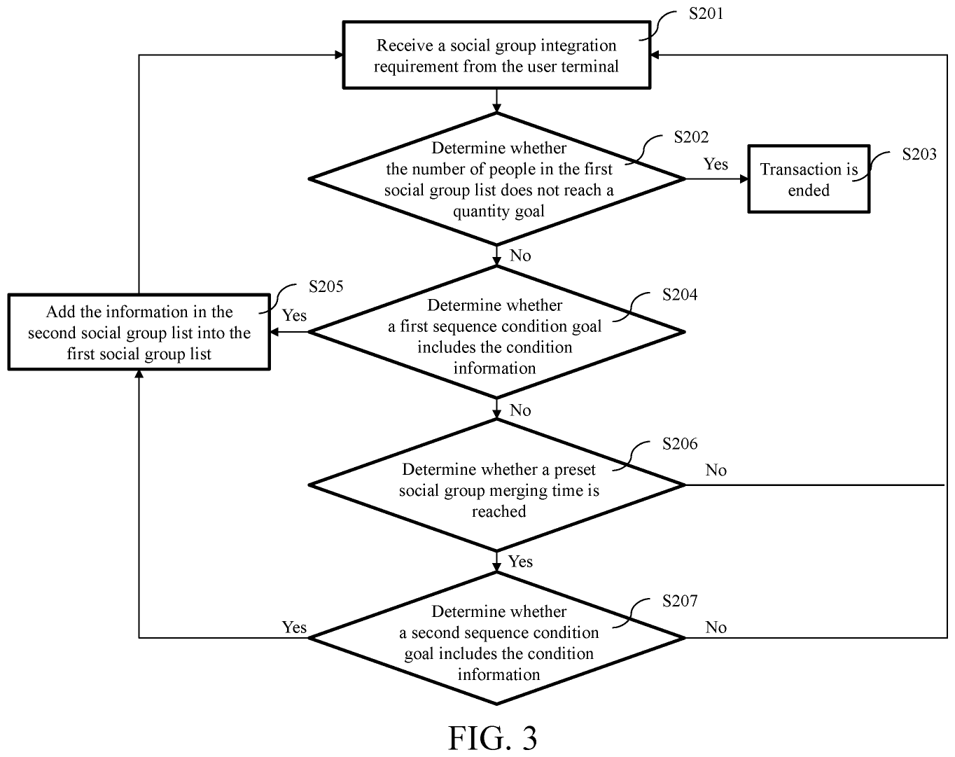

FIG. 3 is a flowchart of a method for social group data management according to another embodiment of the present disclosure, please refer to FIG. 3. After receiving the social group integration requirement from the user terminal (step S201), the server 11 will determine whether the number of people in the first social group list does not reach the number goal (step S202). When it is determined that the number of people in the first social group list reaches the number goal (step S202, the judgment result is “Yes”), the group purchase goal is reached, and then the transaction is ended (step S203). In some embodiments, the newly generated social group is a social group with a purpose (for example, group purchase of vegetables), and the social group will be disassociated after the transaction activity is ended (the transaction purpose is reached or failed). In other embodiments, after the transaction activity is ended, the newly generated social group still exists for next transaction. When it is determined that the number of people in the first social group list does not reach the quantity goal (step S202, the judgment result is “No”), the server 11 will determine whether the first sequence condition goal set by the first user includes the condition information set by the second user (step S204). For example, the first sequence condition goal set by the first user is consumers in Taipei City, and the condition information set by the second user is receiving in Da'an District, Taipei City, so that the first sequence condition goal includes the condition information. When the server 11 determines that the first sequence condition goal includes the condition information (step S204, the judgment result is “Yes”), the server 11 will add the information in the second social group list into the first social group list (step S205). Therefore, the second social group is integrated with the first social group to jointly reach the group purchase goal. When the server 11 determines that the first sequence condition goal does not include the condition information (step S204, the judgment result is “No”), the server 11 will determine whether a preset group merging time is reached (step S206). The preset group merging time refers to a preset time point, which may be an absolute time (such as 2023/2/1 0:00 pm) or a relative time (such as a whole month after the first social group is set up). The preset group merging time may be set by the user or automatically generated by the platform. In this embodiment, the preset group merging time refers to a time point before the time point of determining that the transaction is ended, for example, the transaction ending time is 2023/2/1 0:00 pm, and the preset group merging time may be the transaction ending date of one month ago, which is 2023/1/1 0:00 pm.

When the server 11 determines that the preset group merging time is not reached (step S206, the judgment result is “No”), because the condition information of the second social group does not conform to the condition goal set by the first social group, the server 11 will continue to receive the social group integration requirement from the user terminal (step S201) to seek other social groups conforming to the condition goal to be integrated with the first social group; and when the server 11 determines that the preset group merging time is reached (step S206, the judgment result is “Yes”), the server 11 will determine whether the second sequence condition goal set by the first user includes the condition information set by the second user (step S207). For example, the first sequence condition goal set by the first user is the consumers in Taipei city, the second sequence condition goal is the consumers in Taoyuan City and the Yilan City, which are located away from the Taipei city, and the condition information set by the second user is receiving in Yilan City, so the first sequence condition goal does not include the condition information, and the second sequence condition goal includes the condition information. Therefore, the second sequence condition goal may be set by the user at the same time when the first social group is set, and the first sequence condition goal and the second sequence condition goal are uploaded to the server 11; or when the server 11 determines that the preset group merging time is reached (step S206, the judgment result is “Yes”), the server 11 transmits a second sequence condition goal setting requirement to the first user terminal 21, and then receives the setting of the second sequence condition goal from the first user terminal 21.

When the server 11 determines that the second sequence condition goal set by the first user does not include the condition information set by the second user (step S207, the judgment result is “No”), the server 11 will continue to receive the social group integration requirement from the user terminal (step S201) to seek for other social groups conforming to the condition goal to be integrated with the first social group; and when the server 11 determines that the second sequence condition goal set by the first user includes the condition information set by the second user (step S207, the judgment result is “Yes”), the server 11 will add the information in the second social group list into the first social group list (step S205). Therefore, the second social group is integrated with the first social group to jointly reach the group purchase goal. In this embodiment, during the transaction activity, although the logistics cost of shipping goods to the second social group in Yilan City (the second sequence condition goal) is higher than that of shipping the goods to Taipei City (the first sequence condition goal), a profit margin is still acceptable relative to the transaction cost derived from transaction failure. Therefore, in some embodiments, the method for social group data management effectively reduces the transaction cost through the social group integration mode. It is to be noted that the steps in the flowchart according to the embodiment do not need to be carried out according to a numerical sequence of the steps, for example, step S202 and step S203 can be performed after step S204.

In some embodiments, the server 11 will determine whether a preset social group leaving time is reached or not in a process of performing the method for social group data management (for example, after step S108). The preset social group leaving time refers to a preset time point, which may be an absolute time (for example, 2023/2/1 0:00 pm) or a relative time (for example, one month after the first social group is set up). The preset social group leaving time may be set by the user or automatically generated by the platform. Please refer to FIG. 2. After step S108, when the server 11 determines that the preset social group leaving time is reached, the server 11 will directly execute step S111; and when the server 11 determines that the preset social group leaving time is not reached, the server 11 will execute steps S109 to S110. In other words, in this embodiment, the preset social group leaving time is a time demarcation point for determining whether the second user joining the first social group or the second social group integrated with the first social group can independently leave the social group or not: before the preset social group leaving time is reached, the social group leaving behavior of the second user (the second social group) is limited; and after the preset social group leaving time is reached, the second user (the second social group) may freely leave, so that the transaction stability is provided by this platform mechanism. In some embodiments, the preset social group leaving time is set by the first user when setting up the first social group in step S101 to step S102. In other embodiments, the preset social group leaving time is set by the second user when joining the first social group in step S103 to step S104. The server 11 receives the preset social group leaving time setting information from the second user terminal 22, and provides the preset social group leaving time setting information to the first user terminal 21; and the server 11 sets the preset social group leaving time of the second user for the first social group after receiving the preset social group leaving time permitting message from the first user terminal 21. For example, when joining the social group for group purchase, the second user requires to set the preset social group leaving time for the first social group, and can freely leave the social group after the social group leaving time is up. In some embodiments, the preset social group leaving time refers to a time point when a specific event occurs. For example, after joining a live broadcast social group, the second user can freely leave the social group after live broadcast is ended.

Although the present disclosure has been described in considerable detail with reference to certain preferred embodiments thereof, the disclosure is not for limiting the scope of the invention. Persons having ordinary skill in the art may make various modifications and changes without departing from the scope and spirit of the disclosure. Therefore, the scope of the appended claims should not be limited to the description of the preferred embodiments described above.

What is claimed is:

1. A method for social group data management, applying to a server, wherein the server is suitable for being connected to a first user terminal and a second user terminal; and the method comprises:
the server receiving a first social group setup requirement and first user information from the first user terminal, and generating a first social group list in responding to the first social group setup requirement, wherein the first social group list comprises the first user information;
the server receiving a social group joining requirement and second user information from the second user terminal, and adding the second user information into the first social group list in responding to the social group joining requirement;
the server receiving a social group leaving requirement from the second user terminal, and transmitting the social group leaving requirement to the first user terminal; and
the server receiving a permitting message from the first user terminal, and deleting the second user information in the first social group list in responding to the permitting message.

2. The method for social group data management according to claim 1, further comprising:
the server receiving a second social group setup requirement and the second user information from the second user terminal, and generating a second social group list in responding to the second social group setup requirement, wherein the second social group list comprises the second user information; and
the server receiving a social group integration requirement from the second user terminal, and adding information in the second social group list into the first social group list in responding to the social group integration requirement.

3. The method for social group data management according to claim 2, wherein after the step of the server adding information in the second social group list into the first social group list in responding to the social group integration requirement, the method further comprises: the server deleting the second social group list.

4. The method for social group data management according to claim 2, wherein after the step of the server receiving the permitting message from the first user terminal, the method further comprises: the server deleting the information in the second social group list from the first social group list.

5. The method for social group data management according to claim 2, wherein before the step of the server generating the first social group list in responding to the first social group setup requirement, the method further comprises: the server receiving a quantity goal and a first sequence condition goal from the first user terminal;
before the step of the server generating the second social group list in responding to the second social group setup requirement, the method further comprises: the server receiving condition information from the second user terminal; and
after the step of the server receiving the social group integration requirement from the second user terminal, and when the server determines that the first sequence condition goal comprises the condition information and the number of people in the first social group list does not reach the quantity goal, the server adding the information in the second social group list into the first social group list in responding to the social group integration requirement.

6. The method for social group data management according to claim 5, further comprising: the server receiving a second sequence condition goal and a preset social group merging time from the first user terminal; and
after the step of the server receiving the social group integration requirement from the second user terminal, when the server determines that the preset social group merging time is reached, and the second sequence condition goal comprises the condition information and the number of people in the first social group list does not reach the quantity goal, the server adding information in the second social group list into the first social group list in responding to the social group integration requirement.

7. The method for social group data management according to claim 6, wherein after the step of the server receiving the social group integration requirement from the second user terminal, and when the server determines that the preset social group merging time is not reached, the server does not respond to the social group integration requirement.

8. The method for social group data management according to claim 1, further comprising:
the server receiving a second social group setup requirement and the second user information from the second user terminal, and generating a second social group list in responding to the second social group setup requirement, wherein the second social group list comprises the second user information; and
the server receiving a social group integration requirement from the second user terminal, and generating a third social group list in responding to the social group integration requirement, wherein the third social group list comprises the information in the first social group list and the information in the second social group list.

9. The method for social group data management according to claim 8, wherein after the step of the server generating the third social group list in responding to the social group integration requirement, the method further comprises: the server deleting the second social group list.

10. The method for social group data management according to claim 8, wherein after the step of the server receiving the permitting message from the first user terminal, the method further comprises: the server deleting the information in the second social group list from the third social group list.
